(19) United States
(12) Patent Application Publication
(10) Pub. No.: US 2026/0222966 A1
(43) Pub. Date: Jul. 30, 2026

(54) INTEGRATED ACCESS BACKHAUL MANAGEMENT USING A RAN INTELLIGENT CONTROLLER

(71) Applicant: Juniper Networks, Inc., Sunnyvale, CA (US)

(72) Inventors: Arda Akman, San Ramon, CA (US); Burcu Sahin, San Jose, CA (US)

(21) Appl. No.: 19/040,175

(22) Filed: Jan. 29, 2025

(51) Int. Cl. H04W 40/22; H04W 40/24; H04W 92/12

(52) U.S. Cl. CPC H04W 40/22; H04W 40/248; H04W 92/12

(57) ABSTRACT

In general, techniques are described for establishing connections with and controlling nodes of an Integrated Access and Backhaul (IAB) network using a Radio Access Network (RAN) Intelligent Controller (RIC). In one example, a method comprises configuring, by the controller for a radio access network (RAN), a connection between the controller and an Integrated Access and Backhaul (IAB) node by configuring an IAB donor to forward packets, sent by the controller, to an IAB node, wherein the connection between the controller and the IAB node comprises one of an E2 connection or an O1 connection.

### TECHNICAL FIELD

The disclosure relates to computer networking and, more specifically, to an Integrated Access Backhaul of a mobile network.

### BACKGROUND

Computer networks have become ubiquitous, and the number of network applications, network-connected devices, and types of network-connected devices are rapidly expanding. Such devices now include computers, smartphones, Internet-of-Things (IoT) devices, vehicles, medical devices, factory equipment, etc. 5G mobile network architectures enhanced the ability to provide communication services using cloud-based network function virtualization (NFV). Specialized networks can be created using the Radio Access Network (RAN) of a mobile network operator combined with functions of a 5G core. For example, networks can be created for a specific service level agreement (SLA), special use cases, or other specific requirements.

3rd Generation Partnership Project (3GPP) standards provide for an Integrated Access Backhaul (IAB) network, a deployment scenario in which the same 5G radio interface and spectrum are used both for Access and Backhaul connections. Access connections are those between end-user devices (UEs) and base stations (gNBs), while Backhaul connections link smaller “child” base stations to the wider network (usually via a “donor” gNB or directly to the core network). Consequently, mobile operators do not need to use dedicated transport such as fiber or microwave links for some backhaul connections. The same 5G NR (New Radio) air interface can carry both access traffic and backhaul traffic, simplifying the deployment and reducing costs. An IAB network deployment can be especially helpful in urban areas where a wired backhaul is difficult or not feasible, temporary mobile deployments, and in remote areas where laying new wireline infrastructure is expensive.

In an IAB network, a donor base station (e.g., gNB) has a traditional backhaul link to the core network (e.g., via fiber). One or more IAB nodes connect wirelessly to the donor base station (alternatively known as a “IAB donor”). In some cases, additional layers of IAB nodes can form a multi-hop chain, extending coverage deeper into areas without reliable wired backhaul.

### SUMMARY

In general, techniques are described for establishing connections with and controlling nodes of an Integrated Access and Backhaul (IAB) network using a Radio Access Network (RAN) Intelligent Controller (RIC). For example, a network system may include an Open Radio Access Network (O-RAN) architecture that includes a non-RT RIC and a near-real-time RIC (near-RT RIC) that each executes different functions and services for RAN functions.

In an example of the described techniques, the RIC may communicate with each IAB node of the IAB nodes by establishing a new IP connection to support an E2 connection or O1 connection. In one example, the IP connection utilizes the pre-existing F1 interface for the IAB node, thereby enabling the RIC to interface with and control the IAB node. In such examples, the RIC may establish the IP connection by establishing a new data radio bearer (DRB) over the F1 logical interface to exchange E2 and/or O1 communications with the IAB node. In another example, the RIC may establish an E2 or O1 connection via the IAB Donor distributed unit (DU) over the existing IP traffic mapping. In such examples, the mapping data maps the destination IP for the IAB node to a backhaul channel of the IAB Donor DU for the IAB node, and the IAB Donor DU may forward E2 and/or O1 traffic destined to the IAB Donor node from the RIC using the mapping data.

Establishing E2 and/or O1 connections with IAB nodes using the new IP connection may enable the RIC to control and optimize aspects of the IAB network. For example, the RIC may control and optimize multi-hop backhauling and topology adaptation. As another example, the RIC may control and optimize scheduling and quality of service (QoS) assurances. As another example, the RIC may control the flows processed by various IAB nodes throughout the system to control and optimize congestion. As another example, the RIC may control route management and link failure recovery to improve the network's uptime and reliability.

The techniques of the disclosure provide one or more technical advantages that realize one or more practical applications. For example, control and optimization of an integrated access backhaul by a RIC improves the overall IAB operation. That is, by using a RIC to dynamically monitor and adapt the IAB topology (e.g., evaluate network conditions, determine which IAB nodes connect to which donors and/or other IAB nodes, determine where to reroute traffic through the network, etc.), the RIC can use its centralized and more extensive information about the network to enhance network performance. Similarly, by using a RIC to manage the integrated access backhaul, the RIC may improve allocation of radio resources for users of the network. For example, the RIC may dynamically adjust the resource blocks of various nodes in the network based on traffic demand and priority, enhancing the ability of critical backhaul traffic (e.g., emergency communications) to flow through the network.

In another example, by using the RIC to enforce quality of service policies across the network, the RIC may enhance network stability and usability. For example, the RIC may monitor traffic flow across the network and redirect traffic to enhance the network (e.g., eliminating congestion, balancing traffic loads across nodes, and prioritizing high-priority applications).

In another example, the RIC may enhance the overall health of the network by monitoring the health of individual backhaul links and identifying failures in various links or nodes. For example, the RIC may determine when various components of the backhaul fail or otherwise experience errors that affect the usability of the network. The RIC may therefore reconfigure nodes and connections within the backhaul to improve connectivity.

In an example, this disclosure is directed to a controller for a radio access network (RAN), the controller comprising: processing circuitry; and one or more memories coupled to the processing circuitry, the one or more memories storing instructions that, when executed, cause the processing circuitry to: configure a connection between the controller and an Integrated Access and Backhaul (IAB) node by configuring an IAB donor to forward packets, sent by the controller, to an IAB node, wherein the connection between the controller and the IAB node comprises one of an E2 connection or an O1 connection.

In an example, this disclosure is directed to an Integrated Access and Backhaul (IAB) donor comprising: processing circuitry; and one or more memories coupled to the processing circuitry, the one or more memories storing instructions that, when executed, cause the processing circuitry to: forward, based on one or more messages received from a controller via a first connection, packets sent by a controller to an IAB node to implement a second connection between the controller and the IAB node.

In an example, this disclosure is directed to a method comprising: configuring, by the controller for a radio access network (RAN), a connection between the controller and an Integrated Access and Backhaul (IAB) node by configuring an IAB donor to forward packets, sent by the controller, to an IAB node, wherein the connection between the controller and the IAB node comprises one of an E2 connection or an O1 connection.

This summary is intended to provide an overview of the subject matter described in this disclosure. It is not intended to provide an exclusive or exhaustive explanation of the systems, devices, and methods described in detail within the accompanying drawings and description below. Further details of one or more examples are set forth in the accompanying drawings and the description below. Other features, objects, and advantages will be apparent from the description and drawings, and from the statements provided below.

### BRIEF DESCRIPTION OF DRAWINGS

FIG. 1 is a block diagram illustrating an example network system, in accordance with one or more aspects of this disclosure.

FIGS. 2A-2B are flow charts illustrating an example process of establishing an E2 connection between a RIC and an IAB node, in accordance with one or more techniques of this disclosure.

FIG. 3 is a block diagram illustrating an example SMO, including a non-RT RIC, and an example near-RT RIC, in accordance with one or more techniques of this disclosure.

FIG. 4 is a block diagram illustrating an example of a near-RT RIC performing route management operations, in accordance with one or more aspects of this disclosure.

FIGS. 5A-5C are a series of block diagrams illustrating an example of a near-RT RIC performing link failure and recovery operations, in accordance with one or more aspects of this disclosure.

FIG. 6 is a block diagram illustrating an example of a near-RT RIC configuring and managing a network in a mesh topology, in accordance with one or more aspects of this disclosure.

FIG. 7 is a block diagram illustrating a near-RT RIC performing topology discovery and management, in accordance with one or more aspects of the present disclosure.

FIG. 8 is a flow diagram illustrating example operations of a controller to establish a connection with an IAB node, in accordance with one or more techniques of this disclosure. Like reference characters denote like elements throughout the text and figures.

### DETAILED DESCRIPTION

A radio area network (RAN) may be configured in accordance with Open Radio Access Network (O-RAN) standards (“O-RAN architecture”). The RAN includes one or more Open Central Units (OCUs), Open Distributed Units (O-DUs), and Open Radio Units (O-RUs). An O-CU node is made up of a Control Plane (CP) logical component designated as an O-CU-CP, and a User Plane (UP) logical component designated as an O-CU-UP. The RAN may include one or more O-RAN eNodeBs (O-eNBs), O-RAN gNodeBs (O-gNBs), or the like. An E2 node is a logical node terminating the E2 interface. An IAB node or IAB donor, O-CU-CPs, O-CU-UPs, O-DUs, O-eNBs, and O-gNBs are all non-limiting examples of E2 nodes.

Network densification is a key component of RANs, given the necessity of implanting numerous transport sites, often in areas where a wired connection (e.g., fiber) is unavailable or too costly. However, network densification may be impacted by many factors, including the space and weight of equipment needed to enable wireless backhaul technologies. For instance, some areas where a transport site may be deployed may lack the means to connect the transport site to the network over a direct connection.

An Integrated Access and Backhaul (IAB) architecture enables deployment of assets using wireless backhaul technologies. The IAB architecture involves deploying one or more IAB donors (e.g., base stations directly connected to the network over a wired link). The IAB donor may connect to numerous IAB nodes (i.e., nodes indirectly connected to the core network by connections to one more IAB donors), which themselves may be connected to additional IAB nodes to reach a user equipment (UE), such as a cellular device. Thus, the IAB architecture allows RANs to operate with greater flexibility and scalability by allowing for the placement of transport sites across a wide variety of areas and environments.

In the O-RAN IAB architecture, the core mobile network may connect directly with a node of the network (e.g., the IAB donor) through the NG interface, establishing connections between the core network and the node's O-CU-CP and O-CU-UP. The IAB donor may then locate IAB nodes that can wirelessly transmit data between a UE and the core network. The donor may establish a wireless backhaul link to such IAB nodes using the Backhaul Adaptation Protocol (BAP) and Radio Link Control (RLC) protocols. After the link is established, the O-CUs of the IAB donor may set up an F1 interface with the O-DU of the IAB node(s), allowing for communication between the IAB donor and the IAB node(s). The IAB node(s) may then establish connections with various UEs. Further details on services and functions provided by the IAB architecture can be found in 3rd Generation Partnership Project 2018, Technical Specification Radio Access Network; Study on integrated access and backhaul; (Release 16), TS 38.874, V16.0.0 (2018 December), the entire contents of each of which are hereby incorporated by reference.

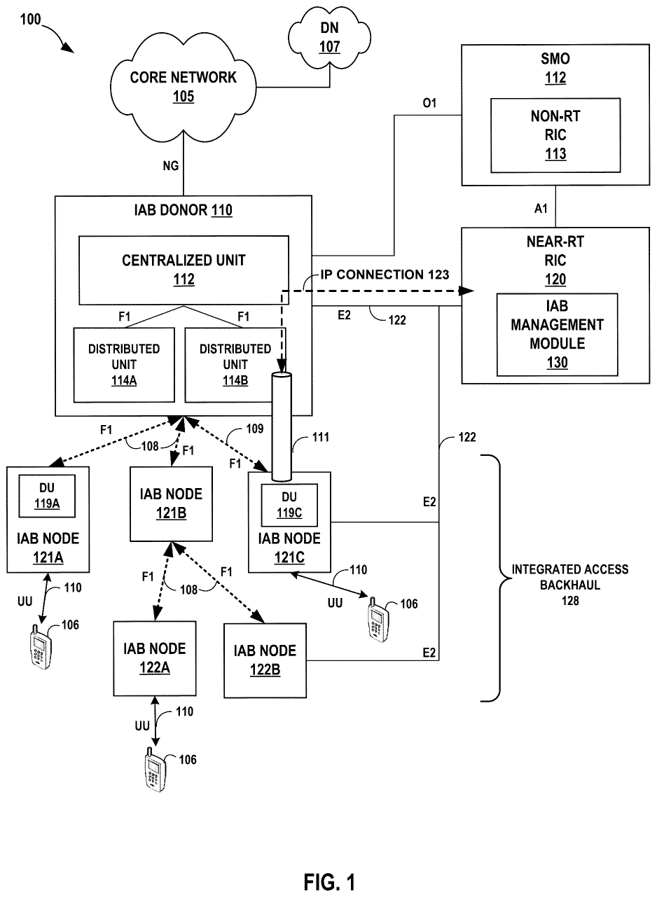

FIG. 1 is a block diagram illustrating an example network system 100, in accordance with one or more techniques of the disclosure. In the example illustrated in FIG. 1, network system 100 includes core network 105, IAB donor 110, SMO 112 including non-RT RIC 113, and near-RT RIC 120. Core network 105 may provide user equipment 106 (hereinafter, “UEs 106”) with access to one or more applications or services provided by a data network 107. In some examples, core network 105 may be, or may be a part of, a mobile network, such as a 5G or xG mobile network. UEs 106 may represent smartphones, desktop computers, laptop computers, tablets, smart watches, and/or “Internet-of-Things” (IoT) devices, such as cameras, sensors, televisions, appliances, or the like.

As shown in FIG. 1, network system 100 also includes IAB donor 110 that provides network access, data transport, and other services to UEs 106 and IAB nodes throughout the network, such as and IAB nodes 121A-120C (collectively, “IAB nodes 121”) and/or IAB nodes 122A-122B (collectively, “IAB nodes 122”). Although described in the context of an Open Radio Access Network (O-RAN), in some examples, IAB donor 110 may be a node of a 5G RAN, a 4G LTE RAN, another 3GPP RAN, another type of RAN, or a combination of the above. Each of IAB donor 110 and IAB nodes 121 may include an access node for a 3GPP network, a fixed or mobile node, a gNodeB (gNB), an eNodeB, another type of NodeB or base station, or a combination thereof. Each of IAB donor 110 and IAB nodes 121 may provide access to user equipment. IAB donor 110 may be a donor gNB or another type of donor node. IAB donor 110 interacts with a plurality of IAB nodes that each includes radio equipment, such as IAB nodes 121 and/or IAB nodes 122. Collectively, IAB nodes 121 and IAB nodes 122 (“IAB nodes 121, 122”) form Integrated Access Backhaul 128 (hereinafter, “IAB 128” or “IAB network 128”).

Example network system 100 includes Service Management and Orchestration (SMO) 112, including non-RT RIC 113 configured in accordance with Open Radio Access Network (O-RAN) standards to manage and/or monitor aspects of a RAN and/or 5G core. SMO 112 can orchestrate and control management and automation aspects of IAB donor 110 (e.g., network slicing, management, and orchestration of O-Cloud, etc.). Further, SMO 112 may control aspects of non-RT RIC 113 and near-RT RIC 120. Non-RT RIC 113 can provide non-real-time (e.g., greater than one second) control and optimization of RAN elements and resources, such as RUs, DUs, and CUs, workflow management, and policy-based control of applications and features of near-RT RIC 120. Near-RT RIC 120 can provide near-real-time (e.g., milliseconds) control and optimization of RAN elements and resources via fine-grained data collection and actions via E2 connections 122 with E2 nodes, such as IAB donor 110 and IAB nodes 121. Near-RT RIC 120 may be implemented with a computing system located within an edge or regional cloud, on-premises of a mobile network operator, a cloud provider, or elsewhere.

Non-RT RIC 113 and near-RT RIC 120 each executes different functions and services for RAN functions. Non-RT RIC 113 may onboard one or more applications (e.g., rApps) that provide non-real time (e.g., greater than one second) control of RAN elements and their resources. Non-RT RIC 113 may onboard one or more applications that manage non-real time events within non-RT RIC 113, such as applications that do not require response times of less than one second. The applications may leverage the functionality exposed via the non-RT RIC framework of non-RT RIC 113. The applications may be used to control and manage RAN elements and resources, such as near-RT RIC 120, RAN nodes, and/or resources in the O-RAN cloud. The applications may also utilize network data, performance metrics, and subscriber data to provide recommendations for network optimization and operational guidance to one or more applications of near-RT RIC 120. Any one or more of applications may be executed by a third party, separate from non-RT RIC 113. Similarly, near-RT RIC 120 may onboard one or more applications (e.g., xApps) that provide near-real time control of RAN elements and their resources.

The O-RAN architecture includes several interfaces, such as A1, O1, O2, F1, NG, Uu, and E2 interfaces, that are each used to provide the functions and services by which the SMO and RIC can configure or direct other components of the RAN. For example, the functions and services of non-RT RIC 113 may include policy management services and/or enrichment information services for near-RT RIC 120 that are provided over an A1 interface (collectively referred to herein as “A1 services” because they provided over the A1 interface); Operations, Administration, and Management (OAM) services, such as performance management services and configuration management services, for O-RAN management elements that are provided over an O1 interface (referred to herein as “O1 services” because they are provided over the O1 interface); infrastructure management services and deployment management services for resources of an O-RAN cloud that are provided over an O2 interface (referred to herein as “O2 services” because they are provided over the O2 interface); control and optimization of RAN elements and resources via fine-grained data collection and actions via E2 interface (referred to herein as “E2 services” because they are provided over the E2 interface); communication services between CUs and DUs within the network architecture over the F1 interface (referred to herein as “F1 services” because they are provided over the F1 interface); and/or other services, such as service management and exposure (SME) services (e.g., registration of a service, update of a service registration), data management and exposure (DME) services, and/or AI/ML services. An IAB architecture may implement one or more changes to one or more interfaces from a standard O-RAN architecture. For instance, in an IAB architecture, the F1 link may be carried over multiple wireless transmissions or hops, instead of being a direct connection between a CU and DU.

Non-RT RIC 113 may provide services using A1, O1, and O2 interfaces. An A1 interface connects the non-RT RIC 113 and near-RT RIC 120. Non-RT RIC 113 may perform services via the A1 interface, such as policy management services (e.g., creation and update of a policy), ML model management services, and/or enrichment information services. An O1 interface may connect SMO 112 with O-RAN managed elements, such as near-RT RIC 120 and/or other RAN nodes (e.g., Open Centralized Unit (O-CU), Open Distributed Unit (O-DU)). Non-RT RIC 113 may perform services via the O1 interface, such as configuration management services and performance management services of O-RAN managed elements (e.g., operation and maintenance (OAM) services), fault supervision, file management, heartbeat, trace, physical network function (PNF) discovery, software management, etc.). An O2 interface may include an interface that connects SMO 112 to resources of the O-RAN O-Cloud. The O-Cloud may include one or more physical infrastructure nodes that host O-RAN functions (e.g., virtual network functions), the supporting software components, and the appropriate management and orchestration functions. Non-RT RIC 113 may perform services via the O2 interface, such as services that provide infrastructure management and/or network function deployment of the resources in the O-Cloud (e.g., discovery and administration of O-Cloud resources; Scale-In, Scale-Out of cloud/deployments; Fault, Configuration, Accounting, Performance, and Security (FCAPS) of cloud/deployments, software management of cloud platform/deployments; create/delete deployment and associated allocated O-Cloud resources). Non-RT RIC 113 may also perform other functions and services, such as service management and exposure (SME) services (e.g., registration of a service, update of a service registration), data management and exposure (DME) services, AI/ML services, etc. Near-RT RIC 120 may provide services using the E2 interface. E2 connection 122 provides E2 interface connectivity between near-RT RIC 120 and IAB donor 110 (e.g., via CU 112). Near-RT RIC 120 may perform services via the E2 interface, such as traffic steering, load balancing, quality of service management services (e.g., creation and update of a policy), interference management, routing table creation and management, and more.

IAB donor 110 has a direct connection to core network 105 and provides wireless backhaul connectivity to downstream IAB nodes 121, 122 in IAB 128). The direct connection may be a wired connection. Although not shown in FIG. 1, IAB donor 110 may serve one or more UEs, e.g., via a UU interface with the UEs. IAB donor 110 may be divided into three functional components, the RU, the DU, and the CU, which can be deployed in various configurations. An RU manages the radio frequency layer and has antenna arrays of various sizes and shapes. Distributed units 114A or 114B (collectively, “DUs 114”) may perform lower layer protocol processing (e.g., RLC). Centralized unit 112 (hereinafter “CU 112”) performs the upper layer protocol processing (e.g., RRC). Although IAB donor 110 is depicted without an RU for ease of illustration, IAB donor 110 may contain one or more RUs.

IAB donor 110 connects to core network 105 (e.g., over a high-capacity connection such as fiber) to exchange packets with data network 107. Core network 105 may be a 5G core network, and data network 107 may represent, for example, one or more service provider networks and services, the Internet, third party services, one or more IP-VPNs, an IP-multimedia subsystem, a combination thereof, or other network or combination of networks. In some examples, core network 105 implements various discrete control plane and user plane functions for network system 100. Examples of 5G control plane functions that may be provided by core network 105 include Access Mobility Management Function (AMF) that provides access mobility management services, Session Management Function (SMF) that provides session management services, Policy Control Function (PCF) that provides policy control services, User Data Management (UDM) that provides management of network user data, Network Repository Function (NRF) that provides a repository that can be used to register and discover services in a network operator's network, Authentication Server Function (AUSF) that provides authentication services, Network Slice Selection Function (NSSF), NSMF that may be used to select an instance of an available network slice for use by any of UEs 106, and Network Slice Subnet Management Function (NSSMF) that provides coordination, management, and orchestration of network slice subnet instances (NSSI). Core network 105 may also include User Plane Functions (UPF) that provides packet routing, forwarding and other network data processing functions (e.g., Quality of Service, packet inspection, traffic optimization etc.).

IAB nodes 121, 122 of IAB 128 allow for the exchange of packetized data between UEs 106 or between UEs 106 and one or more applications or services provided by the data network. An IAB node in IAB 128 may connect downstream to another IAB node to provide services or may connect to any of UE 106 to provide services. That is, an IAB node may act as a quasi-UE (e.g., for backhaul purposes) and a service provider (e.g., for access purposes). IAB nodes 121, 122 in IAB 128 may be divided into three functional components: a DU, an RU, and a mobile-termination unit (MT). The DU of an IAB node, such as DUs 119A and 119C, may perform lower layer protocol processing. The DU may be responsible for managing the traffic and providing downstream coverage to one or more IAB nodes 121, 122 or UEs 106. For instance, the DU of IAB node 121B (not shown for ease of illustration purposes) may provide coverage to each of IAB nodes 122, while DU 119A and DU 119C may provide coverage to UE 106 over UU connection 110. The MT may be responsible for connecting an IAB node upwards (e.g., to another DU). For instance, the MT of IAB node 121B (not shown) may connect to any of DUs 114. In this way, an IAB node may act as a UE for the purposes of communicating with a parent node (e.g., IAB node 122A to intermediate, parent IAB node 121B). MT and the parent DU may communicate over the F1 logical interface, which may be transmitted over an established RRC connection between the MT and the parent IAB node. The MT may also terminate lower-layer protocols (e.g., RLC). An RU manages the radio frequency layer and has antenna arrays of various sizes and shapes. Each IAB node may have one or more functions that may transmit packets between the MT and DU to enable communications between the two. Although IAB nodes 121, 122 of IAB 128 are depicted without an MT for ease of illustration, each of IAB nodes 121, 122 may contain one or more MTs. Similarly, although the IAB nodes 121, 122 of IAB 128 are depicted without an RU for ease of illustration, each of IAB nodes 121, 122 may contain one or more RUs.

Each of the nodes in IAB 128 may attempt to join the IAB upon powering on or otherwise activating. The MT of an IAB node may initiate a discovery mode (e.g., a scan) to locate a suitable parent node (e.g., another IAB node in IAB 128 or IAB donor 110). The MT may initiate an RRC connection to the parent DU. For instance, in one example, the MT of IAB node 122A may initiate a discovery and locate IAB node 121B. The MT of IAB node 122A may initiate the RRC connection to the DU of IAB node 121B to begin communications.

Once the connection is established, an IAB node may request permission from CU 112 to join the network. The DU of the IAB may prepare an F1 Setup Request, including information related to the identity and or capabilities of the DU. To send the request to CU 112, the DU of the IAB node may use one or more relay functions to transmit the information to the MT of the IAB node. The MT, in turn, may use the one or more backhaul links (e.g., an RRC connection) to transmit the request to the parent DU. The process may be repeated until the request is received by CU 112. For instance, in the previous example, the DU of IAB node 122A may prepare the F1 Setup Request and relay the request to the MT of IAB node 122A. The MT of IAB node 122A may transmit the request to the DU of IAB node 121B, which in turn may relay the request to the MT of IAB node 121B. The MT of IAB node 121B may transmit the request to any of DUs 114, which may in turn transmit the request over the F1 interface to CU 112.

In response to receiving the F1 Setup Request, CU 112 may evaluate IAB nodes 121, 122 capabilities, identification information, resource requirements, and more, to determine whether the IAB node may be permitted to join the network. In some examples, CU 112 may base its decision on one or more policies received by near-RT RIC 120 and/or non-RT RIC 113 (e.g., regarding resource allocation, quality of service requirements, etc.). If CU 112 approves the F1 Setup Request, CU 112 may create an F1 Setup Response. The F1 Setup Response may include information such as RRC parameters or DU configuration data. CU 112 may forward the F1 Setup Response to the IAB node in the same method as was used to send the F1 Setup Request. For instance, in the case of the previous example, CU 112 may forward the response to one of DU 114s, which may forward the response to the MT of IAB node 121B. MT of IAB node 121B may relay the response to the DU of IAB node 121B, which in turn may forward the response to the MT of IAB node 122A. The MT of IAB node 122A may relay the response to the DU of IAB node 122A. Upon receiving the response, the DU of IAB node 122A may join the network and begin broadcasting (e.g., to be utilized by other IAB nodes 121, 122 and/or UEs 106). The DU of IAB node 122A and the CU of IAB donor 110 may begin to communicate over the logical F1 interface. If CU 112 denies the F1 Setup Request, it may send an F1 Setup Failure message to IAB node 122A in a manner similar to transmission of the F1 Setup Response. The F1 Setup Failure message may indicate IAB node 122A is prohibited from joining the network.

Once an IAB node is accepted into a network, the IAB node may be managed in part by CU 112 and DUs 114 of IAB donor 110. For instance, in some examples, CU 112 may oversee RRC procedures, enforce one or more policies (e.g., quality of service policies, policies created by near-RT RIC 120 and/or non-RT RIC 113, etc.), and/or configure packet routing in each of IAB node 121, 122 and/or UEs 106. CU 112 may be configured to reconfigure the network. For instance, in one example, CU 112 may alter the parameters of one or more DUs of one or more IAB nodes 121, 122. In another example, CU 112 may alter the connections of one or more IAB nodes 121, 122 (e.g., alerting the parent or children nodes of one or more IAB nodes). In some examples, DU 114s may implement lower-layer radio functions (e.g., RLC), manage backhaul resource allocations, and/or manage broadcast information.

This disclosure describes techniques for enabling near-RT RIC 120 and non-RT RIC 113 to manage IAB nodes 120 and IAB nodes 122 by establishing an IP connection between nodes in IAB 128 and components of the RIC (e.g., near-RT RIC 120 and/or non-RT RIC 113). In accordance with techniques of this disclosure, near-RT RIC 120 and non-RT RIC 113 manage IAB nodes 121 and IAB nodes 122 by establishing an IP connection with downstream IAB nodes 121, 122.

In some examples, near-RT RIC 120 and/or non-RT RIC 113 may establish a link to any of IAB nodes 121, 122 by creating one or more new bearers. For instance, near-RT RIC 120 and/or non-RT RIC 113 may establish new data radio bearers (DRBs) for E2 and O1 connections, respectively. The DRBs may be configured to transport traffic over F1 connections 108, 109. For example, during the F1 setup process, near-RT RIC 120 may transmit a message to IAB donor 110 that causes IAB donor 110 to establish a data radio bearer (e.g., DRB 111) between IAB donor 110 and IAB node 121C to support the connection (e.g., over the F1-U interface of F1 109). The new DRB 111 may transport specific F1 traffic (e.g., a subset of the one or more packets transported between IAB nodes in IAB 128 and/or between IAB nodes in IAB 128 and DUs 114). To cause IAB donor 110 to notify Near-RT RIC 120 in order to transmit the message to establish the data radio bearer, near-RT RIC 120 may earlier transmit a different message to IAB donor 110, such as an E2 Insert message, requesting that IAB donor 110 inform near-RT RIC 120 when an IAB node attempts to join IAB 128, e.g., with an F1 Setup Request to IAB donor 110. For instance, IAB node 121C may attempt to join the network. During the F1 setup process, near-RT RIC 120 may receive the F1 Setup Request from IAB node 121C and may establish DRB 111 for E2 communications that may be transported as F1 traffic. In addition to or as part of sending the F1 Setup Response back to IAB node 121C, IAB donor DU 114B may direct IAB node 121C to update its bearer configurations (e.g., over RRC procedures). After the F1 setup process is complete, IAB node 121C may create an E2 Setup Request that may be transported across the established F1 bearer.

In other examples, the RIC may establish a link to nodes in IAB 128 over existing IP traffic mappings. Near-RT RIC 120 may configure IAB donor 110 with mapping data that maps an Internet Protocol address of an IAB node of IAB 128 (e.g., IAB node 121C) to a backhaul (BH) channel between IAB donor 110 and the IAB node. When forwarding IP packets, DUs 114 may perform the traffic mapping from IP-layer to layer-2, with the mapping information being configured by the CU 112. DUs 114 may transport traffic across the network (e.g., between IAB 128 and near-RT RIC 120) based on respective destination IP information of one or more devices. CU 112 may configure the mapping data according to Table 1.

TABLE 1

| | | | IE Type and |
|---|---|---|---|
| IE/Group Name | Presence | Range | Reference |
| IP-to-layer-2 | | 1 . . . | |
| mapping | | <maxnoofMappingEntries> | |
| information Item | | | |
| >Mapping | M | | 9.3.1.100 |
| Information Index | | | |
| >IP header | M | | 9.3.1.97 |
| information | | | |
| >BH Information | M | | 9.3.1.114 |

The mapping data may include IP header information, such as IP header information according to Table 2. For instance, the IP header information may include a Destination IAB Transport Network Layer (TNL) Address. The Destination IAB TNL Address is the IP address for one of the IAB nodes of IAB 128. For instance, in the example of FIG. 1, the IP header information may include the Destination IAB TNL Address for IAB node 121C.

TABLE 2

| | | | IE Type and | |
|---|---|---|---|---|
| IE/Group Name | Presence | Range | Reference | Semantics Description |
| Destination IAB | M | | 9.3.1.102 | This IE indicates the |
| TNL Address | | | | destination IPv4 |
| | | | | address, or IPv6 address |
| | | | | or IPv6 prefix of a DL |
| | | | | packet. |
| DS Information | | 0 . . . | | |
| List | | <maxnoofDSInfo> | | |
| >DSCP | M | | BIT STRING | This IE indicates the |
| | | | (SIZE(6)) | DS information of DL |
| | | | | traffic. |
| IPv6 Flow Label | O | | BIT STRING | This IE indicates the |
| | | | (SIZE(20)) | IPv6 Flow Label of DL |
| | | | | traffic. |

The mapping data may include backhaul information that identifies a backhaul channel, e.g., which may be defined and identifiable according to Table 3.

TABLE 3

| | | | IE Type and | |
|---|---|---|---|---|
| IE/Group Name | Presence | Range | Reference | Semantics Description |
| BAP Routing ID | O | | 9.3.1.110 | This IE is not needed for |
| | | | | the BAP control PDU. |
| | | | | For UL F1-U traffic, the |
| | | | | BAP address included in |
| | | | | this IE also indicates the |
| | | | | IAB-donor-DU via which |
| | | | | the DL traffic is |
| | | | | transmitted. |
| Egress BH RLC | | 0 . . . 1 | | |
| CH List | | | | |
| >Egress BH RLC | | 1 . . . | | |
| CH List Item | | <maxnoofEgressLinks> | | |
| >>Next-Hop | M | | BAP Address | This IE identifies the |
| BAP Address | | | 9.3.1.111 | next-hop node on the |
| | | | | backhaul path to receive |
| | | | | the packet. The value of |
| | | | | this IE should be unique |
| | | | | in the whole list. |
| >>Egress BH | M | | BH RLC | This IE identifies the BH |
| RLC CH ID | | | Channel ID | RLC channel in the link |
| | | | 9.3.1.113 | between the IAB |
| | | | | node/IAB-donor-DU and |
| | | | | the node identified by the |
| | | | | Next-Hop BAP Address IE. |
| Non-F1- | O | | ENUMERATED | If present, indicates that |
| Terminating IAB- | | | (true, . . . ) | the Next-Hop BAP |
| donor Topology | | | | Address and Egress BH |
| Indicator | | | | RLC CH ID contained in |
| | | | | this IE pertain to the non- |
| | | | | F1-terminating IAB- |
| | | | | donor topology of the |
| | | | | boundary IAB-node. |

Table 1, Table 2, and Table 3 are drawn from 3rd Generation Partnership Project; Technical Specification Group Radio Access Network; “NG-RAN; F1 application protocol (F1AP), (Release 18),” 3GPP TS 38.473 V18.4.0, December 2024, which is incorporated by reference herein in its entirety.

Although described in respect to near-RT RIC 120 and the E2 interface in both examples, in some examples, these operations may be performed by non-RT RIC 113 utilizing the O1 interface, respectively. Similarly, although FIG. 1 illustrates only near-RT RIC 120 establishing interfaces to IAB nodes in IAB 128 (e.g., through IP connection 123), non-RT RIC 113 may establish an O1 interface to each IAB node in IAB 128, in accordance with the techniques of this disclosure. In some examples, near-RT RIC 120 and non-RT RIC 113 may establish E2 and O1 connections, respectively, with IAB 128 simultaneously.

Upon establishing connections between IAB 128 and near-RT RIC 120, IAB management module 130 may be configured to manage one or more IAB nodes (e.g., nodes in IAB 128) connected to near-RT RIC 120. IAB management module 130 may be an application (e.g., an xApp) executed by components of near-RT RIC 120. IAB management module 130 may be configured to send or otherwise engage in one or more E2AP procedures. For instance, IAB management module 130 may be configured to engage in an E2 control procedure. That is, IAB management module 130 may, in conjunction with other components of near-RT RIC 120, send a RIC Control Request to an E2 node (e.g., any IAB node of IAB 128). The RIC Control Request may include one or more parameters, such as a target action (e.g., what the E2 node should update, in response to receiving the RIC Control Request), set of instructions (e.g., instructions for completing the target action), or a time constraint (e.g., a time limit to perform the target action within). To obtain data necessary to make one or more decisions, IAB management module 130 may send one or more subscriptions to one or more E2 nodes. For instance, IAB management module 130 may, in conjunction with other components of near-RT RIC 120, such as a subscription manager, send an E2 subscription to one or more E2 nodes, to receive updates from the E2 nodes. For instance, in some examples, IAB management module 130 may request periodic updates from the subscribed E2 nodes. In other examples, IAB management module 130 may request updates from the subscribed E2 nodes in response to one or more triggering events occurring (e.g., a degradation of services, a change in connected UEs and/or IAB nodes, etc.). IAB management module 130 may also set a default policy that the E2 node should adhere to (e.g., autonomously) to perform various RAN and/or IAB functions.

In some examples, IAB management module 130 may be configured to schedule resources throughout the IAB network. For instance, IAB management module 130 may be configured to run one or more resource allocation algorithms to determine appropriate resource apportionments throughout IAB 128. For instance, in one example, IAB management module 130 may allocate 33.3% of the resources of IAB donor 110 to each of IAB nodes 120. IAB management module 130 may further direct each IAB node in IAB 128 of their resource allocations. For instance, IAB management module 130 may direct IAB node 120A and IAB node 120C to allocate 100% of their resources to access traffic, since neither node possesses any child IAB nodes. IAB management module 130 may direct IAB node 120B to allocate 70% of its traffic to backhaul traffic (e.g., 35% of resources available for each of IAB nodes 122), while maintaining 30% of its resources for its own access traffic (e.g., UEs not illustrated in the example of FIG. 1). IAB management module 130 may dynamically alter the resource allocations of any node in IAB 128 in response to changes in IAB 128. For instance, IAB management module 130 may allocate less resources to IAB node 120A and IAB node 120C to allocate more resources to IAB 120B (e.g., to support the backhaul network). When an IAB node, such as IAB node 122B, becomes disconnected, IAB management module 130 may allocate more resources to IAB node 120A and IAB node 120C, since IAB node 120B has less backhaul traffic to support.

In other examples, IAB management module 130 may be configured to manage one or more other RAN and/or IAB functionalities. For instance, IAB management module 130 may be configured to manage congestion within IAB 128 and adjust the topology of IAB 128 in response. In another example, IAB management module 130 may adjust the topology of IAB 128 in response to another degradation of service. For instance, in one example, IAB node 122B may be a mobile unit (e.g., a unit attached to one or more moving objects, such as a vehicle). IAB node 122B may notify IAB management module 130, through one or more subscriptions or policies, that connection 108 to IAB node 120B is failing (e.g., a drop in the Reference Signal Received Power of connection 108, due to the physical distance between IAB node 120B and IAB node 122B nearing the maximum range of the wireless connection). In response, IAB management module 130 may preemptively direct IAB node 122B to connect to another IAB node, such as IAB node 120C, that IAB node 122C may be able to obtain a stronger wireless connection to. In another example, IAB management module 130 may be configured to create and/or update one of more routing tables (e.g., in conjunction with CU 112) to perform route management for IAB 128 (e.g., to increase factors in IAB 128, such as latency or throughput). In other examples, IAB management module 130 may be configured to perform actions related to the RAN and IAB architecture, such as link failure and recovery (e.g., determining one or more alternative routes in the event of a failure in IAB 128), the management of one or more mesh networks, or quality of service assurance.

In these ways, near-RT RIC 120 may implement one or more functions to improve and optimize the network. For instance, near-RT RIC 120 may be used to facilitate various scheduling and quality of services features. Near-RT RIC 120 may be configured to allocate resources differently among various users and/or IAB nodes within IAB 128, such that near-RT RIC 120 may dynamically alter the resource allocation, ensuring that quality standards for service may be met. For instance, near-RT RIC 120 may prioritize certain critical traffic, such as communications related to emergencies (e.g., 911 phone calls, AMBER alerts, etc.). In this way, near-RT RIC 120 can ensure that certain communications are properly prioritized, increasing service reliability and stability.

As another example, near-RT RIC 120 may be configured to manage the flow of traffic in IAB 128 to control congestion throughout the system. Near-RT RIC 120 may manage the traffic flow throughout the system in part by analyzing the traffic load for each IAB node of IAB 128. By monitoring the traffic flow across each IAB node, near-RT RIC 120 may determine where congestion is occurring and redirect traffic to alternative nodes in the system. For instance, near-RT RIC 120 may redirect traffic to less congested nodes to avoid high levels of packet loss, increasing the usability and stability of the network for users.

As another example, near-RT RIC 120 may manage the various routes across IAB 128 (e.g., from IAB donor 110 to any of UEs 106) to determine a best path for data traffic within the IAB network. Near-RT RIC 120 may be responsible for building and updating various routing tables to determine available routes in the IAB network. Near-RT RIC 120 may also detect failures of nodes in IAB 128. In response to detecting an IAB node failure, near-RT RIC 120 may re-route traffic around failed nodes or links to reduce the disruption to ongoing services and increase the uptime of the network. For instance, near-RT RIC 120 may be configured to determine when one or more nodes go offline or are otherwise unable to be reached by another node (e.g., due to one or more blockages, such as a moving vehicle, interfering with signals).

The RIC may perform the above actions by communicating with the CU, DU, and RU of the IAB donor(s) over an interface (e.g., the E2 connection with the near-RT RIC or the O1 connection with the non-RT RIC). As described in further detail below, the RIC is enabled to communicate with IAB nodes in the network, e.g., via an E2 or O1 connection. Although IAB node(s) may communicate with the IAB donor(s) over an F1 interface (e.g. between the DU of each IAB node and the CU of the IAB donor), the IAB nodes are unable to communicate with the RIC because the lack of an IP connection prevents establishment of E2 or O1 connection. The techniques permit communication between the RIC and the IAB nodes and allow the RIC to more effectively optimize and control the IAB network as described in the examples above, increasing the flexibility and scalability of the architecture.

Since, under the standard IAB architecture, neither near-RT RIC 120 nor non-RT RIC 113 may directly communicate with IAB nodes of IAB 128, as the E2 and O1 interfaces requires a direct IP connection to IAB donor 110, which is terminated at DUs 114, the techniques herein enable near-RT RIC 120 and non-RT RIC 113 to establish a connection with downstream IAB nodes over E1 and/or O1 interfaces. As such, near-RT RIC 120 or non-RT RIC 112 may assume responsibility of one or more CU 112 management tasks for IAB 128 to improve responsiveness to rapid changes across IAB 128. For instance, near-RT RIC 112 may control IAB link establishment, quality of service assurances, route management, and/or link failure recovery, among other areas, as noted above and described in further detail below.

FIG. 1 illustrates only one particular example of network system 100. In the example of FIG. 1, system 100 might include all of the components shown in FIG. 1. However, in other examples, system 100 may include a subset of the components included and/or may include additional components not shown in FIG. 1.

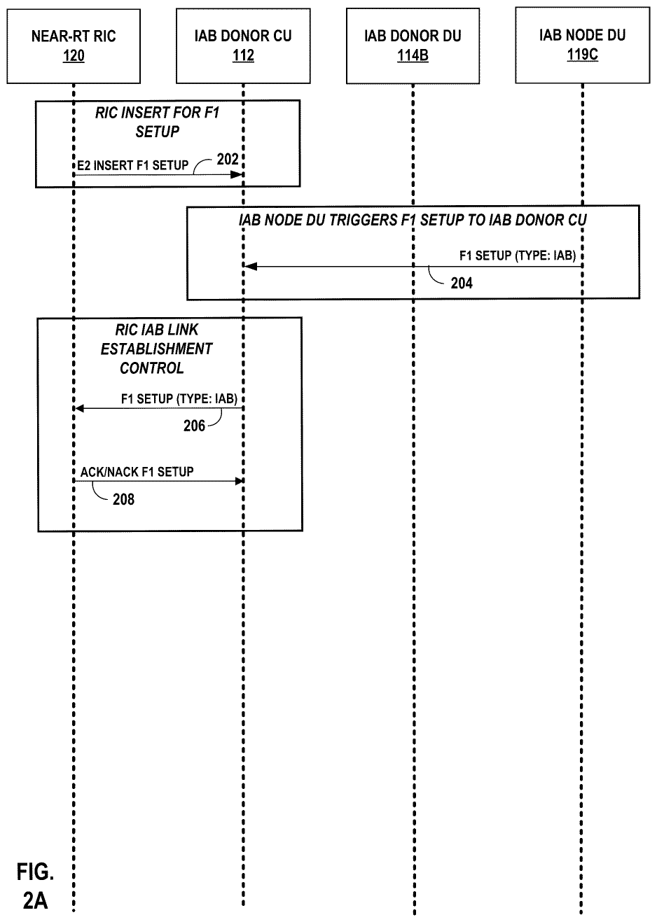

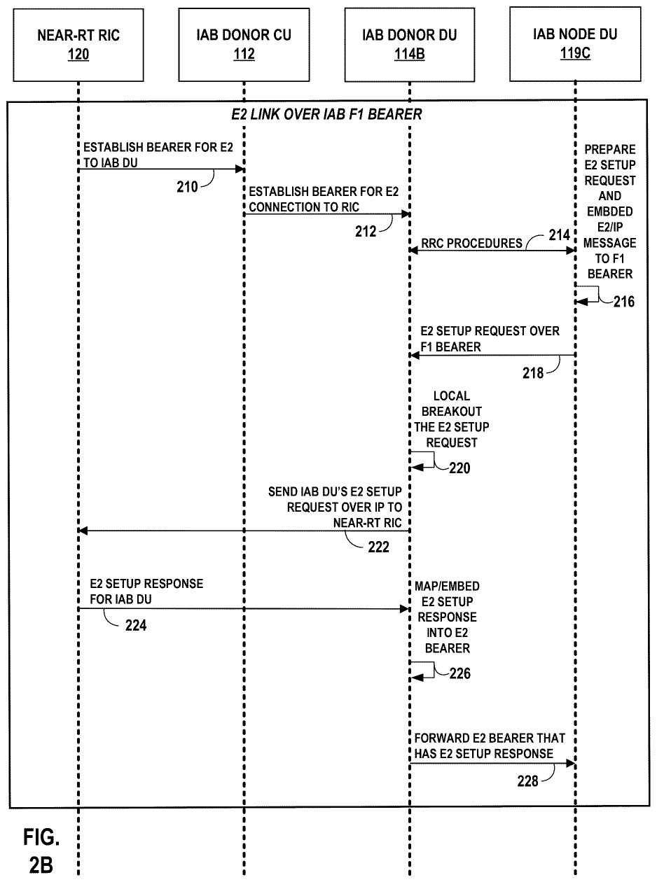

FIGS. 2A-2B are flow charts illustrating an example process of establishing an E2 connection between a RIC and an IAB node, in accordance with one or more techniques of this disclosure. FIGS. 2A-2B are described with respect to FIG. 1 for example purposes.

Near-RT RIC 120 may send one or more messages to IAB donor CU 112 to request that IAB donor CU 112 inform near-RT RIC 120 whenever it receives an indication that a new IAB node is attempting to attach to the network (202). For example, near-RT RIC 120 may request that IAB donor CU 112 inform near-RT RIC 120 whenever IAB donor CU 112 receives an F1 Setup Request. This enables near-RT RIC 120 to evaluate the request and collect information about the IAB node requesting to join the network. The request from near-RT RIC 120 to IAB donor CU 112 (IAB donor 110 being an E2 node) may be a RIC Service INSERT message that specifies an F1 Setup Request as a RIC Event Trigger, effectively subscribing near-RT RIC 120 to F1 Setup Request messages received at donor CU 112. Near-RT RIC 120 is then able to control operations of IAB donor CU 112 after a RIC Event Trigger event. Based on receiving the request from near-RT RIC 120, IAB donor CU 112 may wait to receive one or more F1 Setup Requests from one or more IAB nodes that attempt to attach to the network. The RIC Service INSERT message and other RIC Service messages exchanged between E2 nodes and a RIC are described in “O-RAN Work Group 3 (Near-RT RIC and E2 Interface); E2 General Aspects and Principles (E2GAP),” O-RAN ALLIANCE, version O-RAN.WG3.E2GAP-R004-v06.002004 (2024), which is incorporated herein by reference in its entirety.

IAB node (e.g., IAB node 121C) may attempt to attach to the network with an F1 Setup Request sent from IAB node DU 119C to IAB donor CU 112 (e.g., via RRC) (204). In some examples, the F1 Setup request may include information such as the set of supported cells, quality-of-service (QoS) information for bearer configurations, and information about IAB node DU 119C and the IAB node in general (e.g., identification information). In some examples, the F1 Setup Request may include information regarding a specific type of F1 setup. For instance, IAB node DU 119C may specify the F1 Setup Request as type IAB.

Based on receiving the F1 Setup Request, IAB donor CU 112 may forward the F1 Setup Request to near-RT RIC 120 (206). This forwarding may be based on the RIC Service INSERT message of step 202. Near-RT RIC 120 may determine whether to approve or deny the F1 Setup Request (e.g., whether or not to admit the IAB node to attach to the network) and return an F1 Setup Response or F1 Setup Failure message indicating approval or denial, respectively. (208). If the F1 Setup Request is approved, near-RT RIC 120 may create an F1 Setup Response message (ACK). The F1 Setup response may include information such as approved QoS configuration, information about one or more established bearers over the interface, information about resource configurations for access and/or backhaul links, or information indicating which cells should be activated. Near-RT RIC 120 may send the F1 Setup Response to the IAB node, and the IAB node may attach to the network, establishing the logical F1 interface and F1 bearer 109. If denied (e.g., due to the IAB node failing to meet certain restrictions or qualifications created by near-RT RIC 120), near-RT RIC 120 may create an F1 Setup Failure (NACK), which may be sent back to the IAB node. The IAB node may be prohibited from joining the network and the process ends.

If the F1 Setup Request is approved, near-RT RIC 120 establishes an E2 connection over the new IAB F1 bearer 109 between IAB donor CU 112 and IAB node DU 119C. Near-RT RIC 120 may send a message to IAB donor 110 (e.g., to IAB donor CU 112). The message may cause IAB donor 110 to establish a new data radio bearer between IAB donor 110 and IAB node 121C, more specifically with IAB node DU 119C, to support an E2 connection between near-RT RIC 120 and IAB node 121C (210). Near-RT RIC 120 may send the message to IAB donor 110 via an existing E2 connection with IAB donor 110. (For cases in which non-RT RIC 113 is establishing an O1 connection, non-RT RIC 113 may send the message to IAB donor 110 via an existing O1 connection.) Based on this message, IAB donor CU 112 may establish, along with IAB donor DU 114B, a new data radio bearer (DRB) 111 with IAB node DU 119C via RRC signaling (e.g., by encapsulating data over one or more lower-layer protocols, such as MAC, RLC, and/or PDCP) (212). The bearer may have specific QoS parameters associated with it, such as a priority level. IAB donor CU 112 may direct IAB donor DU 114B to establish the bearer for E2 connections to near-RT RIC 120.

Based on direction from IAB donor CU 112, IAB donor DU 114B and IAB node DU 119C may engage in RRC procedures and communications (214). That is, IAB donor DU 114B may communicate with IAB node DU 119C to update DRB 111 configurations of the IAB node (e.g., enabling the node to operate over the newly established bearer). In some examples, process 214 may involve one or more RRCReconfiguration messages. For instance, IAB donor DU 114B may send one or more RRCReconfiguration commands to IAB node DU 119C. IAB node DU 119C may respond with one or more RRCReconfigurationComplete messages (e.g., to indicate IAB node DU 119C accepted and/or applied the one or more RRCReconfiguration commands).

Once DRB 111 is established, IAB node DU 119C may embed an E2 Setup Request message to F1 bearer 109 (216). E2 Setup Request message is directed to near-RT RIC 120 to allow IAB node DU 119C to act as an E2 node (e.g., a node that may interface with near-RT RIC 120) and utilize the newly established DRB 111 for E2 communications (e.g., over E2AP and/or E2SM). In some examples, the E2 Setup Request message may include information, such as the O-RAN functions and/or configurations IAB node 121C supports or identification information for the IAB node. IAB node DU 119C may send the E2 Setup Request message to IAB donor DU 114B over F1 bearer 109 (218).

Under the standard IAB and O-RAN architectures, the default traffic mapping configures IAB donor DU 114B to send traffic associated with one or more E2 nodes to core network 105. In some examples, to enable IAB donor DU 114B to instead forward the E2 Setup Request to near-RT RIC 120 for E2 connection establishment, IAB donor DU 114B may perform a local breakout (220). That is, rather than sending data to core network 105, IAB donor DU 114B may be configured to break out packets to be sent over a local network (e.g., an intranet). In some examples, rather than performing a local breakout, IAB donor DU 114B may be configured with a traffic mapping that causes IAB donor DU 114B to add an IP address of near-RT RIC 120 to the E2 Setup Request message. In some instances, the traffic mapping may only be configured to occur when there is a limited number of IAB nodes in the network.

IAB donor DU 114B may send the E2 Setup Request to near-RT RIC 120 over IP, e.g., via IP connection 123 represent a layer 3 network and endpoints for IAB donor DU 114B and near-RT RIC 120 (222). Near-RT RIC 120 may receive the E2 Setup Request and determine whether to accept or deny the E2 node (i.e., IAB node 121C). If near-RT RIC 120 decides to admit IAB node 121C, near-RT RIC 120 may send an E2 Setup Response to IAB node DU 119C (224). If near-RT RIC 120 decides to not admit the IAB node, near-RT RIC 120 may send an E2 Setup Failure.

IAB donor DU 114B receives the E2 Setup Response and, because the E2 Setup Response is for IAB node DU 119C, may map or otherwise embed the E2 Setup Response into the new DRB 111 for the E2 connection (226). IAB donor DU 114B may forward the E2 Setup Response via the new DRB 111 for the E2 connection to IAB node DU 119C (228). If the response from near-RT RIC 120 was an E2 Setup Response, the IAB node may be accepted as an E2 node, and able to communicate with, and be managed by, near-RT RIC 120 over the established E2 connection over new DRB 111.

Although described with respect to near-RT RIC 120 and the E2 interface, in some examples, these operations may be performed by non-RT RIC 113 to establish an O1 connection over an O1 interface. For instance, the operations of steps 202-228 may be modified to create an O1 connection over an F1 bearer, allowing non-RT RIC 113 to communicate with IAB node DU 119C. In such examples, E2 Setup Request may be an O1 Setup Request or similar message for the O1 protocol, an E2 Setup Response may be an O1 Setup Response or similar message for the O1 protocol, and so forth.

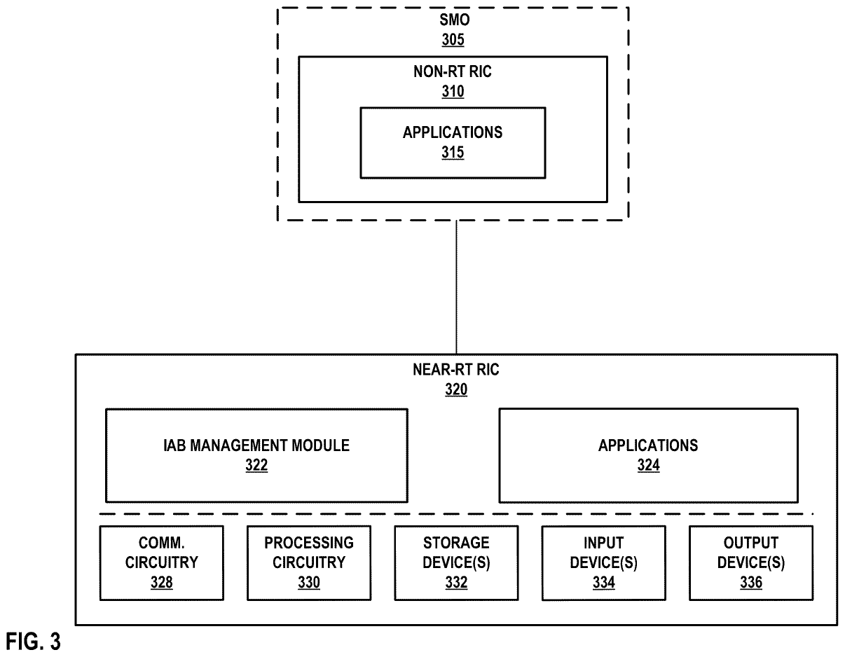

FIG. 3 is a block diagram illustrating an example SMO 305, including a non-RT RIC 310, and an example near-RT RIC 320, in accordance with one or more techniques of this disclosure. Non-rt RIC 310 may include applications 315 (e.g., rApps), and near-RT RIC 320 may include IAB management module 322 and applications 324 (e.g., xApps). Near-RT RIC 320 may also include communication circuitry 328, processing circuitry 330, storage device(s) 332, input device(s) 334, output device(s) 336. IAB management module 322 is an example instance of IAB management module 130, non-RT RIC 310 is an example instance of non-RT RIC 113, and near-RT RIC 320 is an example instance of near-RT RIC 120. In some examples, IAB management module 322 may be one of applications 324. SMO 305 can orchestrate and control management and automation aspects of a radio area network (e.g., network slicing, management, and orchestration of O-Cloud, etc.). Further, SMO 305 may control aspects of non-RT RIC 310 and near-RT RIC 320. Non-RT RIC 310 can provide non-real-time (e.g., greater than one second) control and optimization of RAN elements and resources such as RUs, DUs, and CUs, workflow management, and policy-based control of applications and features of near-RT RIC 320. Near-RT RIC 320 can provide near-real-time (e.g., milliseconds) control and optimization of RAN elements and resources via fine-grained data collection and actions.

Non-RT RIC 310 and near-RT RIC 320 may deploy as a highly scalable, microservices based containerized architecture. In some examples, near-RT RIC 310 may be located within an edge or regional cloud. In some examples, non-RT RIC 310 and/or near-RT RIC 320 are implemented with a cloud computing system, server farm, and/or server cluster (or portion thereof) that provides services to client devices and other devices or systems. In other examples, non-RT RIC 310 and/or near-RT RIC 320 may be implemented through one or more virtualized compute instances (e.g., virtual machines, containers) of a data center, cloud computing system, server farm, and/or server cluster. One or more of the devices, modules, storage areas, or other components of non-RT RIC 310 and near-RT RIC 320 may be interconnected to enable intercomponent communications (physically, communicatively, and/or operatively). In some examples, such connectivity may be provided by communication channels, a system bus, a network connection, an inter-process communication data structure, or any other method for communicating data.

Non-RT RIC 310 may provide non-real-time (e.g., greater than one second) control and optimization of RAN elements and resources such as RUs, DUs, and CUs, workflow management, and policy-based control of applications and features of near-RT RIC 320. Non-RT RIC 310 may be deployed as a highly scalable, microservices based containerized architecture. In this example, non-RT RIC 310 may onboard, deploy, and/or terminate one or more applications 315. Applications 315 may represent applications that leverage the functionality exposed via the framework of non-RT RIC 310. Applications 315 may provide non-RT RIC 310 with nonreal time (e.g., greater than one second) control of RAN elements and their resources. That is, applications 315 may be used to control and manage RAN elements and resources, such as a near-RT RIC, RAN nodes, and/or resources in the O-RAN cloud. Applications 315 may provide one or more services that are performed using interfaces of non-RT RIC 310. For example, applications 315 may include services such as policies for a near-RT RIC, configuration instructions for O-RAN managed elements, performance jobs for O-RAN managed elements, services for managing the services and/or data, or any combination thereof. Applications 315 may provide services for radio resource management, higher layer procedure optimization, policy optimization, and providing guidance, parameters, policies, and AI/ML models to support the operation of RAN functions.

Non-RT RIC 310 may provide non-real-time (e.g., greater than one second) control and optimization of RAN elements and resources such as RUs, DUs, and CUs, workflow management, and policy-based control of applications and features of near-RT RIC 320. Non-RT RIC 310 may be deployed as a highly scalable, microservices based containerized architecture. In this example, non-RT RIC 310 may onboard, deploy, and/or terminate one or more applications 315. Applications 315 may represent applications that leverage the functionality exposed via the framework of non-RT RIC 310. Applications 315 may provide non-RT RIC 310 with nonreal time (e.g., greater than one second) control of RAN elements and their resources. That is, applications 315 may be used to control and manage RAN elements and resources, such as a near-RT RIC, RAN nodes, and/or resources in the O-RAN cloud.

Near-RT RIC 320 can provide near-real-time (e.g., milliseconds) control and optimization of RAN elements and resources via fine-grained data collection and actions. Near-RT RIC 124 may onboard one or more applications, e.g., applications 324 that manage near real time events within near-RT RIC 320. Applications 324 may leverage the functionality exposed via the near-RT RIC framework of near-RT RIC 320. Near-RT RIC 320 may enforce policies received from applications 315 of non-RT RIC 310 and may provide policy feedback to non-RT RIC 310. Although illustrated as within non-RT RIC 310, any one or more of applications 315 may be executed by a third party, separate from non-RT RIC 310. Likewise, although illustrated as within near-RT RIC 320, any one or more of applications 324 may be executed by a third party, separate from near-RT RIC 320. Near-RT RIC 320 may include IAB management module 322. In accordance with the techniques of this disclosure, IAB management module 322 may be configured to control and optimize aspects of an IAB network. For example, IAB management module 322 of near-RT RIC 320 may control and optimize multi-hop backhauling and topology adaptation. As another example, IAB management module 322 of near-RT RIC 320 may control and optimize scheduling and quality of service (QoS) assurances. As another example, the RIC may control the flows processed by various IAB nodes throughout the system to control and optimize congestion. As another example, IAB management module 322 of near-RT RIC 320 may control route management and link failure recovery to improve the network's uptime and reliability.

Communication circuitry 328 may communicate with devices external to near-RT RIC 320 by transmitting and/or receiving data, and may operate, in some respects, as both an input device and an output device. In some examples, communication circuitry 328 may communicate with other devices over a network. In other examples, communication circuitry 328 may send and/or receive radio signals on a radio network such as a cellular radio network. In other examples, communication circuitry 328 may transmit and/or receive satellite signals on a satellite network such as a Global Positioning System (GPS) network. Examples of communication circuitry 328 include a network interface card (e.g., an Ethernet card), an optical transceiver, a radio frequency transceiver, a GPS receiver, or any other type of device that can send and/or receive information. Other examples of communication circuitry 328 may include devices capable of communicating over Bluetooth®, GPS, near field communication (NFC), ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

Processing circuitry 330 may implement functionality and/or execute instructions associated with management of near-RT RIC 320 or associated with one or more modules illustrated herein and/or described herein, including applications 315. Processing circuitry 330 may be, may be part of, and/or may include processing circuitry that performs operations in accordance with one or more aspects of the present disclosure. Examples of processing circuitry 330 include microprocessors, application processors, display controllers, auxiliary processors, one or more sensor hubs, and any other hardware configured to function as a processor, a processing unit, or a processing device. Near-RT RIC 320 may use processing circuitry 330 to perform operations in accordance with one or more aspects of the present disclosure using software, hardware, firmware, or a mixture of hardware, software, and firmware residing in and/or executing at near-RT RIC 320. Any one or more of applications 315 may be hosted by a cloud provider or other third-party.

In some examples, processing circuitry 330 may include any one or more of a microprocessor, a controller, a digital signal processor (DSP), graphics processing unit (GPU), tensor processing unit (TPU), an application specific integrated circuit (ASIC), a field-programmable gate array (FPGA), or equivalent discrete or analog logic circuitry. In some examples, processing circuitry 330 may include multiple components, such as any combination of one or more microprocessors, one or more controllers, one or more DSPs, GPUs, TPUs, one or more ASICs, or one or more FPGAs, as well as other discrete or integrated logic circuitry, which may be physically located in one or more devices in one or more physical locations.

Storage device(s) 332 may store information for processing during operation of non-RT RIC 310. Storage device(s) 332 may store program instructions and/or data associated with one or more of the modules described in accordance with one or more aspects of this disclosure. Processing circuitry 330 and storage device(s) 332 may provide an operating environment or platform for such modules, which may be implemented as software, but may in some examples include any combination of hardware, firmware, and software. Processing circuitry 330 may execute instructions and storage device(s) 332 may store instructions and/or data of one or more modules. The combination of processing circuitry 330 and storage device(s) 332 may retrieve, store, and/or execute the instructions and/or data of one or more applications, modules, or software. Processing circuitry 330 and/or storage device(s) 332 may also be operably coupled to one or more other software and/or hardware components, including, but not limited to, one or more of the components of near-RT RIC 320 and/or one or more devices or systems illustrated as being connected to near-RT RIC 320.

In some examples, one or more of storage device(s) 332 are temporary memories, meaning that a primary purpose is not long-term storage. Storage device(s) 332 may be configured for short-term storage of information as volatile memory and therefore not retain stored contents if deactivated. Examples of volatile memories include random access memories (RAM), read-only memory (ROM), dynamic random-access memories (DRAM), static random-access memories (SRAM), and other forms of volatile memories known in the art. Storage device(s) 332, in some examples, also include one or more computer-readable storage media. Storage device(s) 332 may be configured to store larger amounts of information than volatile memory. Storage device(s) 332 may further be configured for long term storage of information as non-volatile memory space and retain information after activate/off cycles. Examples of non-volatile memories include magnetic hard disks, optical discs, flash memories, or forms of non-volatile RAM (NVRAM), electrically programmable memories (EPROM), or electrically erasable and programmable (EEPROM) memories.

Input device(s) 334 may represent any input devices of near-RT RIC 320 not otherwise separately described herein. One or more input device(s) 334 may generate, receive, and/or process input from any type of device capable of detecting input from a human or machine. For example, input device(s) 334 may generate, receive, and/or process input in the form of electrical, physical, audio, image, and/or visual input (e.g., peripheral device, keyboard, microphone, camera).

Output device(s) 336 may represent any output devices of near-RT RIC 320 not otherwise separately described herein. One or more output device(s) 336 may generate, receive, and/or process input from any type of device capable of detecting input from a human or machine. For example, output device(s) 336 may generate, receive, and/or process output in the form of electrical and/or physical output (e.g., peripheral device, actuator).

FIG. 3 illustrates only one particular example of near-RT RIC 320. In the example of FIG. 3, near-RT RIC 320 might include all of the components shown in FIG. 3. However, in other examples, near-RT RIC 320 may include a subset of the components included or may include additional components not shown in FIG. 3. For instance, while non-RT RIC 310 is depicted including only applications 315, in some examples, non-RT RIC 310 may include one or more IAB management modules. Near-RT RIC 320 may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such systems may perform operations described herein as a result of instructions, stored on a computer-readable storage medium, executing on one or more processors. The instructions may be in the form of software stored on one or more local or remote computer readable storage devices. In other examples, one or more of such computing systems may perform operations using hardware, firmware, or a mixture of hardware, software, and firmware residing in and/or executing at each of such computing systems.

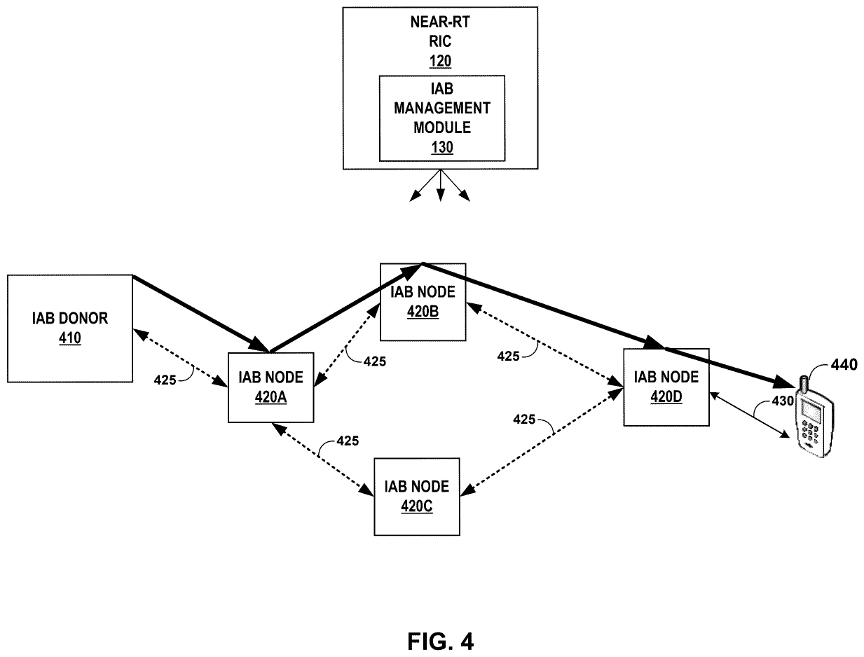

FIG. 4 is a block diagram illustrating an example of near-RT RIC 120 performing route management operations, in accordance with one or more aspects of this disclosure. FIG. 4 illustrates near-RT RIC 120, IAB management module 130, IAB donor 410, IAB nodes 420A-420D (collectively, “IAB nodes 420”), connections 425, and UE 440. Near-RT RIC 120 may use IAB management module 130 to perform route management operations (e.g., selecting one or more paths across the network to the end user) to decrease latency, maximize throughput, and/or decrease traffic and congestion throughout the network. Near-RT RIC 120 may establish E2 connections with IAB donor 410 and/or IAB nodes 420 as described elsewhere in this disclosure.

Under the standard IAB architecture, upon the creation of an IAB node (e.g., IAB node 420A) in a given network (e.g., the node turning on, or otherwise powering on), the IAB node may begin discovering the current network topology to identify the next-hop node (e.g., the next IAB node in the network path that packets may be forwarded to). The IAB node may use measurement metrics, such as the Reference Signal Receive Power (RSRP), Received Signal Strength Indicator (RSSI), or Signal-to-Interference Plus Noise Ratio (SINR), to determine which node should be selected (e.g., due to connection quality).

Each of the IAB nodes (e.g., any of IAB nodes 420) may be configured to monitor connection quality to each connected IAB node in the network (e.g., over one of connection 425). For instance, IAB node 420A may monitor the connection quality of connections 425 to IAB node 420B and IAB node 420C. Each of the IAB nodes may send updated information on connection quality to the CU of the IAB donor (e.g., IAB donor 410). For instance, an IAB node may send the IAB donor's CU information, such as the RSRP, SINR, RSSI, packet error rate (PER). In some examples, the IAB nodes may be configured to provide updates to the CU on a schedule (e.g., once every minute). In other examples, the IAB nodes may be configured to provide updates to the CU based on one or more degradation events (e.g., noticeable quality changes in one or more connections, node down or failure events, etc.) or alterations to connections 425 (e.g., the termination of connection 425).

In response to receiving connection information from the IAB nodes, the CU of the IAB donor (e.g., IAB donor 410) may be configured to create one or more routing tables, which may contain routing information configured on each node, such as the DU of each IAB node. In some examples, the routing table for a node may contain information specific to the node, such as destination address, the next path to follow (e.g., the next-hop node, backhaul link, backhaul RLC channel, etc.), and/or a cost metric (i.e., an estimate of the quality, efficiency, or operability of the link, based on factors such as latency, signal quality, etc.). In some examples, the CU may calculate information, such as the cost metric for each next-hop node, based on various metrics received from the DUs (e.g., latency, PER, etc.).

The network may attempt to send one or more data packets to UE 440. For each packet, an intermediate IAB-node selects the next hop node for data transmission according to the routing table and the destination address carried in the packet's adaptation info. In case the routing table holds multiple next-hop entries for the same destination address, it selects the next hop based on the cost metric. However, under the standard IAB architecture, the CU may lack the ability to properly update factors, such as the cost metric, for each IAB node in a network, especially as large 5G and 6G networks expand, since the CU may only update the routing table in response to periodic measurements and feedback from the DUs of each of IAB nodes 420. As such, the CU may be unable to update the routing table in response to rapid changes in network conditions (e.g., quality of any of connections 425, status of any of IAB nodes 420, etc.).

In accordance with techniques of this disclosure, near-RT RIC 120 may use IAB management module 130 to communicate with any of IAB nodes 420 over the F1 interface utilizing the E2 connections created as described elsewhere in this disclosure. That is, near-RT RIC 120 may use IAB management module 130 to manage, on its own or in conjunction with the CU of IAB donor 410, the route management table. IAB management module 130 may communicate with any of IAB nodes 130 to receive data, from IAB nodes 420 and/or IAB donor 410, in real-time time (e.g., 10 ms to 1000 ms). The data may include information on connection quality, updates based on one or more events, or other information conventionally provided to CU to enable CU to manage routing tables of IAB nodes 420 and/or IAB donor 410. Based on the data from the IAB nodes 420 and/or IAB donor 410, IAB management module 130 may create and/or edit routing tables of IAB nodes 420 and/or IAB donor 410. For instance, in the example of FIG. 4, the routing table may be configured to cause the IAB network of IAB donor 420 and IAB nodes 420 to forward packets on a path from IAB donor 410 to UE 430 via IAB node 420A, IAB node 420B, and IAB node 420D, as indicated by the solid bold arrows.

The use of near-RT RIC 120 and IAB management module 130 may enable the routing tables of IAB donor 410 and/or IAB nodes 420 to be updated more quickly (e.g., in real-time) in response to changes in network conditions. For instance, in one example, connection 425 between IAB node 420B and 420D may rapidly deteriorate and be unsustainable (e.g., unable to transmit any packets between IAB node 420B and IAB node 420D) or otherwise unusable (e.g., high levels of packet loss, low transmit rate speeds, etc.). Under the standard IAB architecture, the CU may be unable to detect said deterioration in time and continue to route packets to UE 430 according to a path that includes connection 425. This, in turn, may cause failure along the path, which may cause the CU to finally recalculate or recreate the routing table and trigger a route update by communicating with IAB nodes 420 over the F1 interface. This may cause additional negative impacts to the network, such as delays in transmitting data to UE 430 or additional levels of packet loss. Continuing the example, according to techniques of this disclosure, IAB management module 130 may be configured to detect deterioration in any of connections 425 in real-time, allowing near-RT RIC 120 to update the routing tables more quickly. This, in turn, may cause the IAB network to route around failure within the IAB network, for near-RT RIC 120 may update the routing tables in time to prevent IAB nodes 420 from forwarding packets on connection 425 between IAB nodes 420B and 420D.

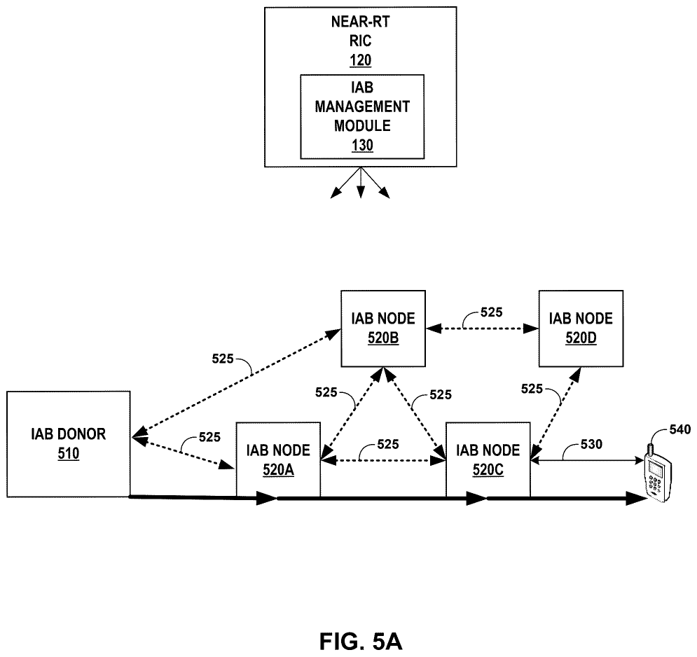

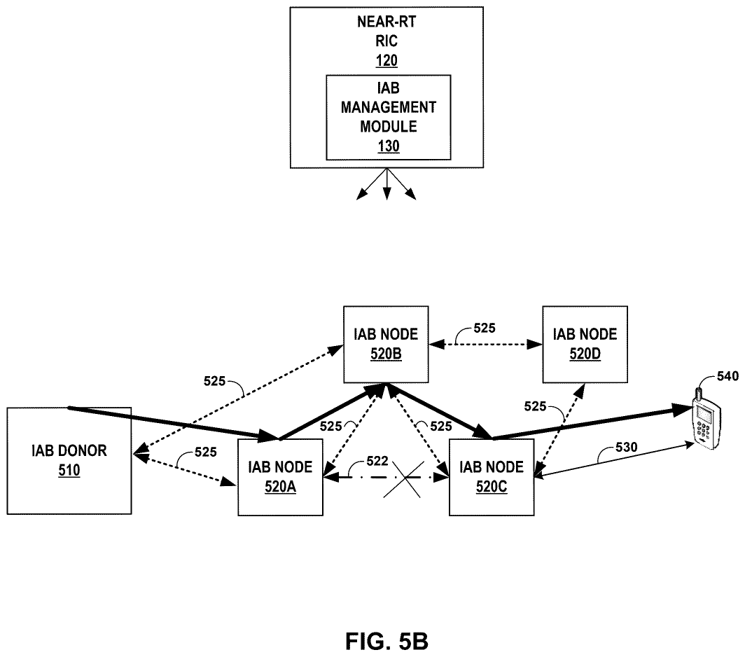

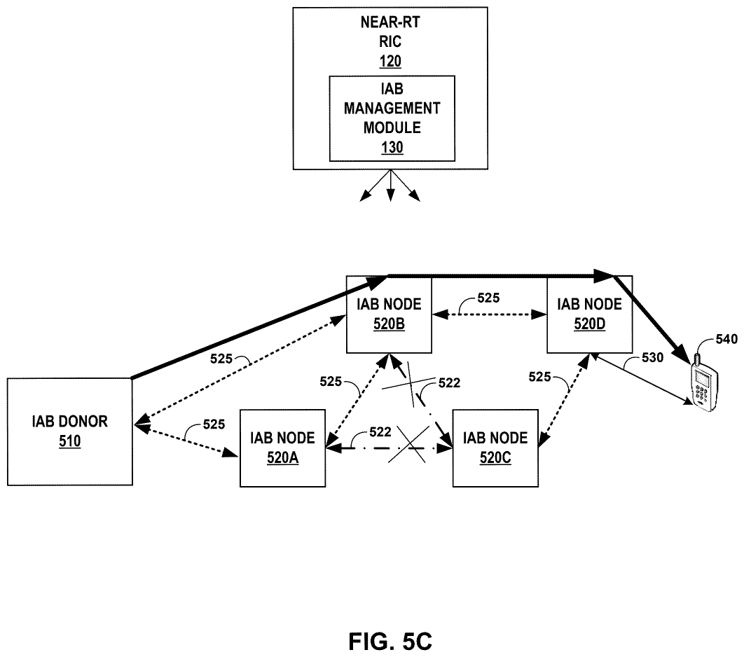

FIGS. 5A-5C are block diagrams illustrating an example of near-RT RIC 120 performing link failure and recovery operations, in accordance with one or more aspects of this disclosure. FIGS. 5A-5C illustrate near-RT RIC 120, IAB management module 130, IAB donor 510, IAB nodes 520A-520D (collectively, “IAB nodes 520”), connections 525 (as indicated by dotted lines), connection 530, and UE 540. Near-RT RIC 120 may use IAB management module 130 to perform link failure and recovery operations (e.g., failure detection, path recovery, traffic routing, etc.) to increase successful packet transmittals across the network. Near-RT RIC 120 may establish E2 connections with IAB donor 510 and/or IAB nodes 520 as described elsewhere in this disclosure.

FIG. 5A depicts the network as fully operational and stable (e.g., no errors present). The IAB network transmits data from IAB donor 510 to UE 540 via IAB node 520A and IAB node 520C.

FIG. 5B depicts a failure in the network, leaving IAB node 520A and IAB node 520C unable to communicate (as indicated by connection 522 between IAB node 520A and IAB node 520C being dashed and dotted). IAB management module 130 configures IAB donor 510 and/or IAB nodes 520 to forward traffic according to the route from IAB donor 510 to UE 540 via IAB node 520A, IAB node 520B, and IAB node 520C.

Under the standard IAB architecture, the CU of the IAB donor may be configured to receive updates from any of IAB nodes regarding link failures in any of the connections (e.g., unsustainable levels of latency, high levels of signal drop in RSRP and/or SINR, etc.). In response to receiving a fault report from an IAB node, the CU may reconfigure one or more routing tables and send updates to IAB nodes over the F1 interface. However, this may result in downtime for the network, as the CU collects data, reconfigures the routing table, and sends reconfiguration requests to nodes throughout the network.

According to the techniques of this disclosure, near-RT RIC 120 uses IAB management module 130 and E2 connections with IAB donor 510 and/or IAB nodes 520 to more quickly update routing tables in response to failures in the network. In one example, IAB management module 130 may be configured to monitor, in near-RT, each of IAB nodes 520 to more quickly determine failure events across the network and update routing tables accordingly. IAB management module 130 may dynamically determine alternative route options (e.g., cause IAB node 520A and IAB node 520B to establish connection 525). In another example, IAB management module 130 may be configured to monitor, in near-RT, each of IAB nodes 520 to obtain information that may be used to update components of the routing table (e.g., cost metrics). In the example of FIG. 5B, IAB management module 130 may determine that the connection between IAB node 520A and IAB node 520C has failed, and IAB management module 130 may update routing tables and prior to data being transmitted according to the prior configuration, thereby avoiding failures during the data transmittal process that may lead to negative impacts on the network for the end user (e.g., packet loss, slower transmittal time due to the need to reconfigure the routing table during transmittal, etc.).

In the example of FIG. 5C, a second failure may occur in the network, leaving IAB node 520B and IAB node 520C unable to communicate. As such, IAB management module 130 configures IAB donor 510 and/or IAB nodes 520 to forward traffic from IAB donor 510 to UE 540 via IAB node 520A, IAB node 520B, and IAB node 520D. In some examples, IAB management module 130 may be configured to determine a new routing path in response to the failure of the connection between IAB node 520B and IAB node 520C. In other examples, IAB management module 130 may be configured to update the routing configuration based on one or more predetermined routing configurations, in response to the failure of the connection between IAB node 520B and IAB node 520C.

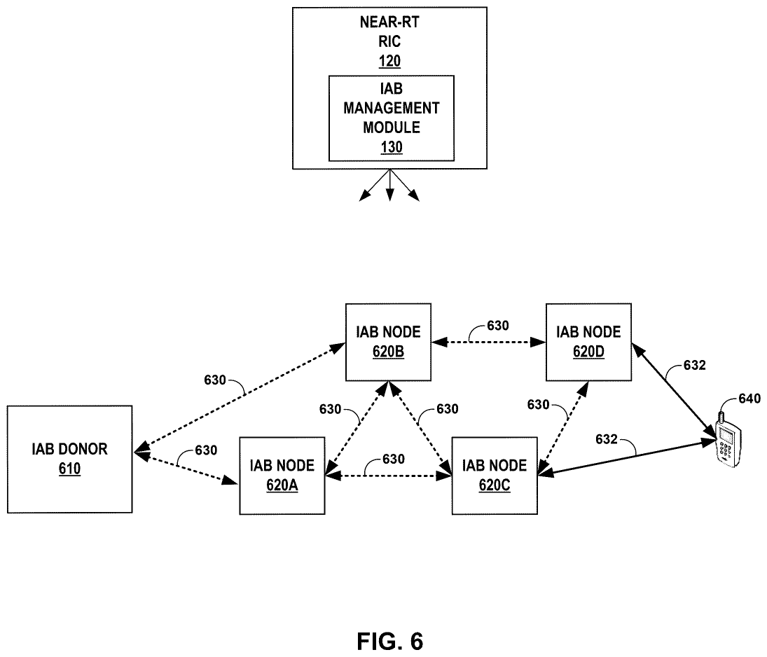

FIG. 6 is a block diagram illustrating an example of the near-RT RIC configuring and managing a network in a mesh topology, in accordance with one or more aspects of this disclosure. In the example illustrated in FIG. 6, the figure includes near-RT RIC 120, IAB management module 130, IAB donor 610, IAB nodes 620A-620D (collectively, “IAB nodes 620”), connections 630, connection 632, and UE 640. Near-RT RIC 120 may use IAB management module 130 to configure the network in a mesh topology to increase the resilience and flexibility of the network. Near-RT RIC 120 may establish E2 connections with IAB donor 610 and/or IAB nodes 620 as described elsewhere in this disclosure.

In the standard IAB architecture, the CU of the donor may be configured to set up the network to allow multiple connections among each of the IAB nodes to create a mesh topology. That is, each of the IAB nodes may connect to any other of neighboring IAB nodes, creating multiple paths throughout the network. If any connections or IAB nodes fail, there exist alternative routes for transmitting data from the IAB donor to a UE. The CU may create and manage the routing tables by collecting information from each of the IAB nodes.

The CU of IAB donor 610 may decide a routing configuration through a mesh IAB network based on data routinely received from each of IAB nodes 620 (e.g., relating to latency, signal strength, etc.). However, the CU may be unable to quickly determine failures within the network and/or issues that may affect the performance of the network (e.g., congestion across a given path). In accordance with aspects of this disclosure, near-RT RIC 120 may, in conjunction with the CU of IAB donor 610, manage the routing table and network using IAB management module 130 via E2 connections with IAB donor 610 and/or IAB nodes 620. For instance, IAB management module 130 may be configured to communicate with each of IAB nodes 620 in near-real time to obtain up-to-date information (e.g., data load, latency when communicating to another of IAB nodes 620, etc.). By obtaining this information more frequently from IAB nodes 620, IAB management module 130 may update the routing tables to more accurately reflect the current conditions of the network, decreasing factors such as congestion and PER while increasing factors such as transmit rate.

In some examples, IAB management module 130 may be configured to perform quality of service processes (e.g., to route traffic based on priority). For instance, in one example, IAB donor 610 may receive a request to transmit voice data across the network to UE 640. IAB management module 130 may be configured to determine the path with the lowest latency for transmitting the voice data, while IAB management module 130 may route other data types (e.g., those with a lower priority) according to standard routing paths.

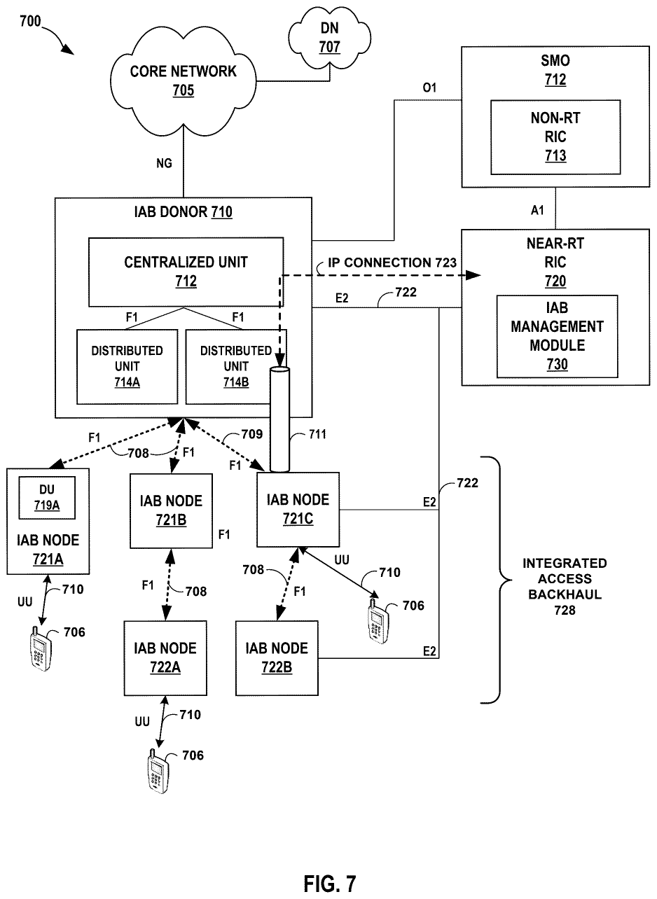

FIG. 7 is a block diagram illustrating a near-RT RIC performing topology discovery and management processes, in accordance with one or more aspects of the present disclosure. System 700 of FIG. 7 is similar to system 100. Near-RT RIC 720, IAB management module 730, IAB donor 710, IAB 728, IAB nodes 720A-720C (collectively, “IAB nodes 721”), and IAB nodes 722A-722B (collectively, “IAB nodes 722”) may correspond to near-RT RIC 120, IAB management module 130, IAB donor 110, IAB 128, IAB nodes 121, and IAB nodes 122, respectively. However, in other examples, operations described in FIG. 7 may be performed by one or more other components, modules, systems, or devices. Further, in other examples, operations described in connection with FIG. 7 may be merged.

IAB management module 730 may adjust the topology of IAB 728 in response to a degradation of service. That is, IAB management module 730 may direct an IAB node in IAB 728 to alter one or more of connections 708 in response to a change in the status of IAB 728. For instance, IAB node 722B may represent a non-stationary wireless node (e.g., a node attached to one or more moving objects, such as a vehicle). In the example of FIG. 1, IAB node 722B may be connected to IAB node 721B, which IAB node 722B and/or IAB management module 730 may have determined was the optimal connection for IAB node 722B (e.g., based on distance to each of IAB nodes 721, one or more signal measurements such as RSRP or Received Signal Strength Indicator, resource allocations, etc.). However, as IAB node 722B may move, connection 708 to IAB node 721B may begin to deteriorate (e.g., due to the physical distance between IAB node 721B and IAB node 722B approaching the maximum range of the wireless connection). IAB management module 730 may direct IAB node 722B to connect to a new IAB node in IAB 728 to achieve a stronger connection. IAB node 722B may connect to IAB node 721C. However, in other examples, IAB node 722B may connect to other sources in system 700, including IAB nodes in IAB 728, such as IAB node 721A or IAB node 722A, or IAB donor 710.

In some examples, IAB management module 730 may receive an indication from IAB node 722B of the signal degradation (e.g., through one or more subscriptions or policies). In other examples, IAB management module 730 may receive information on the signal degradation through one or more periodic updates sent by IAB node 722B. In some examples, IAB node 722B may autonomously (e.g., without prompting from IAB management module 730) determine, or request IAB management module 730 to determine, a new connection for IAB node 722B, in procedure with one or more policies provided to IAB node 722B by components of near-RT RIC 721, such as IAB management module 730.

In some examples, IAB management module 730 may change the topology of the network to increase the fairness of resource allocations and/or decrease congestion throughout IAB 728. For instance, in one example, IAB management module 730 may determine that IAB node 721B is unable to sufficiently serve one or more downstream devices (e.g., IAB nodes 722, UEs connected to IAB node 722A, etc.) with the current resource allocation. Instead of reallocating additional resources to IAB node 721B (e.g., to provide more resources for IAB node 721B to share with IAB nodes 722), IAB management module 730 may direct IAB node 722B to connect to another node in IAB 728, such as IAB node 721C. IAB management module 730 may direct IAB nodes 721B and 721C to update their own resource allocations to account for the changes in backhaul nodes requiring resources from the nodes. In other examples, IAB node 722B may connect to other sources in system 700, including IAB nodes in IAB 728, such as IAB node 721A, or IAB donor 710.

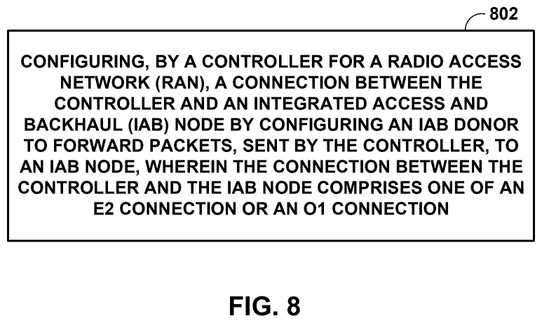

FIG. 8 is a flow diagram illustrating example operations of a controller to establish a connection with an IAB node, in accordance with one or more techniques of this disclosure. The example operations are described with respect to system 100 of FIG. 1, in particular near-RT RIC 120. However, in other examples, operations described in FIG. 8 may be performed by one or more other components, modules, systems, or devices. For example, operations described may be performed by another system of FIG. 1, such as non-RT RIC 113. Further, in other examples, operations described in connection with FIG. 8 may be merged, performed in a different sequence, omitted, or may encompass additional operations not specifically illustrated or described.

In the example operations of FIG. 1, near-RT RIC 120 configures a connection (e.g., E2 connection 122) between the near-RT RIC 120 and IAB node 121C by configuring IAB donor 110 to forward packets, sent by near-RT RIC 120, to IAB node 121C. The connection between the controller and IAB node 121C may be E2 connection 122 as shown, or where the controller is a non-RT RIC can be an O1 connection (802). In some instances, the connection may be established by the creation of one or more DRBs.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A controller for a radio access network (RAN), the controller comprising:
processing circuitry; and
one or more memories coupled to the processing circuitry, the one or more memories storing instructions that, when executed, cause the processing circuitry to:
configure a connection between the controller and an Integrated Access and Backhaul (IAB) node by configuring an IAB donor to forward packets, sent by the controller, to an IAB node,
wherein the connection between the controller and the IAB node comprises one of an E2 connection or an O1 connection.

2. The controller of claim 1, wherein the instructions cause the processing circuitry to configure the connection via one of an E2 connection with the IAB donor or an O1 connection with the IAB donor.

3. The controller of claim 1, wherein to configure the IAB donor to forward packets, sent by the controller, to the IAB node, the instructions cause the processing circuitry to configure the IAB donor with mapping data that maps an Internet Protocol address of the IAB node to a backhaul channel between the IAB donor and the IAB node.

4. The controller of claim 1,
wherein to configure the connection between the controller and the IAB node, the instructions cause the processing circuitry to send a first message to the IAB donor, and
wherein the first message causes the IAB donor to establish a data radio bearer between the IAB donor and the IAB node to support the connection.

5. The controller of claim 4, wherein the instructions cause the processing circuitry to send the first message to the IAB donor via one of an E2 connection with the IAB donor or an O1 connection with the IAB donor.

6. The controller of claim 4, wherein the data radio bearer comprises an F1 bearer.

7. The controller of claim 4,
wherein to configure the connection between the controller and the IAB node, the instructions cause the processing circuitry to send a second message to the IAB donor,
wherein the second message causes the IAB donor to send an F1 setup message, sent by the IAB node, to the controller.

8. The controller of claim 7, wherein the instructions cause the processing circuitry to send the first message to the IAB donor based on the F1 setup message.

9. The controller of claim 4,
wherein the instructions cause the processing circuitry to receive, from the IAB donor, an E2 Setup Request message sent by the IAB node and received at the IAB donor via the data radio bearer, and
wherein the E2 Setup Request message is in accordance with an E2 interface protocol and requests the connection between the controller and the IAB node.

10. The controller of claim 1, wherein the controller comprises one of a near-real time or non-real time RAN Intelligent Controller.

11. The controller of claim 1, wherein the instructions cause the processing circuitry to configure the IAB node via the connection.

12. The controller of claim 1, wherein the instructions cause the processing circuitry to configure, via the connection, a routing table of the IAB node that controls forwarding by the IAB node among one or more nodes of an IAB network, the IAB network including the IAB node.

13. An Integrated Access and Backhaul (IAB) donor comprising:
processing circuitry; and
one or more memories coupled to the processing circuitry, the one or more memories storing instructions that, when executed, cause the processing circuitry to:
forward, based on one or more messages received from a controller via a first connection, packets sent by a controller to an IAB node to implement a second connection between the controller and the IAB node.

14. The IAB donor of claim 13, wherein the first connection comprises one of an E2 connection with the controller or an O1 connection with the controller.

15. The IAB donor of claim 13, wherein the instructions cause the processing circuitry to:
store mapping data included in the one or more message, wherein the mapping data maps an Internet Protocol address of the IAB node to a backhaul channel between the IAB donor and the IAB node; and
forward, based on the mapping data, the packets sent by the controller to the IAB node.

16. The IAB donor of claim 13, wherein the instructions cause the processing circuitry to, based on the one or more messages, establish a data radio bearer between the IAB donor and the IAB node to support the second connection.

17. The IAB donor of claim 13, wherein the instructions cause the processing circuitry to:
receive, via the data radio bearer, an E2 Setup Request message sent by the IAB node, wherein the E2 Setup Request message is in accordance with an E2 interface protocol and requests the second connection between the controller and the IAB node; and
send the E2 Setup Request message to the controller.

18. The IAB donor of claim 17,
wherein the instructions cause the processing circuitry to send, via the data radio bearer, an E2 Setup Response message from the controller, and
wherein the E2 Setup Response message is responsive to the E2 Setup Request message.

19. The IAB donor of claim 13, wherein the instructions cause the processing circuitry to send, based on the one or more messages, an F1 setup message, sent by the IAB node, to the controller.

20. A method comprising:
configuring, by a controller for a radio access network (RAN), a connection between the controller and an Integrated Access and Backhaul (IAB) node by configuring an IAB donor to forward packets, sent by the controller, to an IAB node,
wherein the connection between the controller and the IAB node comprises one of an E2 connection or an O1 connection.
